(19) United States
(12) Patent Application Publication
(10) Pub. No.: US 2004/0066462 A1
(43) Pub. Date: Apr. 8, 2004

(54) Peripheral component interconnect (PCI) card for controlling a motorized zoom lens of a camera

(76) Inventor: Mark Medow, Hollywood, FL (US)

Correspondence Address: Law Office - Dinesh Agarwal, P.C., Suite 330, 5350 Shawnee Road, Alexandria, VA, 22312, US

(21) Appl. No.: 10/265,377

(22) Filed: Oct. 7, 2002

(51) Int. Cl. H04N 5/225

(52) U.S. Cl. 348/335

(57) ABSTRACT

A peripheral component interconnect (PCI) card for enabling communication between a component and a host computer, includes a microprocessor for receiving an input command from the computer and generating a digital signal to be communicated to the component. A digital-to-analog converter is provided, preferably on the PCI card, for converting the digital signal to an analog signal before communication to the component. The PCI card can be used to control a motorized zoom lens of a camera directly from a computer.

### BACKGROUND OF THE INVENTION

The present invention is directed to peripheral component interconnect cards, and more particularly to a peripheral component interconnect (PCI) card for controlling a motorized zoom lens of a camera directly from a standard computer.

A monitoring video camera apparatus typically includes a video camera, a computer for sending commands to the camera, and a chassis containing a control receiver positioned between the computer and the camera. Generally, two mechanisms are involved. One mechanism controls pan or tilt of the camera, while the second mechanism controls the motorized zoom lens of the camera. The control receiver receives commands from the PC, and then sends the appropriate controlling signal to the motorized lens of the camera to adjust the zoom, focus, and iris, or to perform pan and tilt functions of the camera. In some cases, the chassis may employ a joystick or push-buttons to allow direct human control of the camera lens.

The conventional systems, therefore, utilize a separate control component, i.e., chassis, positioned in between the computer and the motorized zoom lens of the camera. Accordingly, the conventional systems are not very desirable in that various camera positions, particularly that of the motorized zoom lens, cannot be directly controlled from the computer.

Therefore, there is a need in the industry for a system that allows controlling various camera functions, particularly those of the motorized zoom lens, directly from a computer, such as a PC (personal computer).

Various video camera apparatus are disclosed in U.S. Pat. Nos. 5,450,140; 5,949,574; 6,191,814 B1; 6,300,976 B1; 6,356,303 B1; 6,392,693 B1; and Japanese JP 09009129 A. Various circuit boards are disclosed in U.S. Pat. Nos. 4,031,371; 4,330,684; 4,347,446; 4,519,401; 4,524,240; 4,583,150; 4,903,230; 5,333,307; 5,347,190; 5,627,842; 5,897,628; 5,903,744; 5,926,803; 5,978,940; 5,987,633; 6,021,266; 6,230,307; Des. 374,866; Des. 412,887; and Des. 428,860.

### OBJECTS AND SUMMARY OF THE INVENTION

The principal object of the present invention is to provide a PCI card for controlling a camera's motorized zoom lens directly from a computer.

An object of the present invention is to provide a system for controlling a camera's motorized zoom lens by using a PCI (peripheral component interconnect) card without an additional chassis.

Another object of the present invention is to provide a system for controlling a camera's motorized zoom lens directly from a computer by using a single PCI card.

Yet another object of the present invention is to provide a PCI card which can be directly connected to a motherboard of a computer for controlling the motorized zoom lens of a camera.

Still yet another object of the present invention is to provide a PCI card which eliminates additional power adapters and supplies. In particular, the PCI card of the invention generates all the required voltages and currents.

Still yet another object of the present invention is to provide a PCI card which can generate all the different types of digital and analog signals necessary to fully control the motorized lens, and particularly the zoom, focus, and iris functions thereof.

An additional object of the present invention is to provide a PCI card which is protected from transient motor voltages, or other power or electrostatic surges, spikes, and over-voltages.

Yet an additional object of the present invention is to provide a system for controlling a camera's motorized zoom lens which uses only one cable with a standard DB25 connector between the PCI card and the motorized lens. All power and signal communications are transmitted on this multiwire cable.

Still yet an additional object of the present invention is to provide a system for controlling a camera's motorized zoom lens directly from a computer wherein a graphical user interface (GUI) presents menus for the user to control the lens using the keyboard and a pointing device, such as a mouse.

Still yet an additional object of the present invention is to provide a system for controlling a camera's motorized zoom lens wherein the same PCI card can be loaded with different software for controlling different types of lenses.

Still yet an additional object of the present invention is to provide a system for controlling a camera's motorized zoom lens wherein other software programs can interface and control the PCI card by communicating with the GUI.

A further object of the present invention is to provide a PCI card which can automatically focus while the user is only performing the zoom function of the motorized lens. This allows the image to remain sharp and focused throughout the zooming procedure.

Yet a further object of the present invention is to provide a PCI card which includes an externally available reset button to allow the user to manually bypass all the embedded software and GUI to reboot the PCI card without having to reboot the host computer, if needed.

In summary, the main object of the present invention is to provide a PCI card which allows control of a camera's motorized zoom lens directly from a computer without the need for an additional chassis.

In accordance with the present invention, a peripheral component interconnect card for enabling communication between a component and a host computer, includes a microprocessor for receiving an input command from the computer and generating a digital signal to be communicated to the component. A digital-to-analog converter is provided, preferably on the PCI card, for converting the digital signal to an analog signal before communication to the component.

In accordance with the present invention, a control system for a camera having a motorized lens with variable positions, includes a computer with a screen. The computer includes a control component for outputting a signal to actuate the motorized lens to adjust a position of the lens. The control component is disposed in the computer and is operably connected to the motorized lens such that signals from the control component control the motorized lens.

### BRIEF DESCRIPTION OF THE DRAWINGS

The above and other objects, novel features and advantages will become apparent from the following detailed description of the invention, as illustrated in the drawings, in which:

FIG. 1 is a schematic illustration of a setup illustrating a camera and a computer;

FIG. 2 is a schematic illustration of a PCI card in accordance with the present invention; and

FIG. 3 is a flow chart illustrating control of the camera lens.

### DETAILED DESCRIPTION OF THE INVENTION

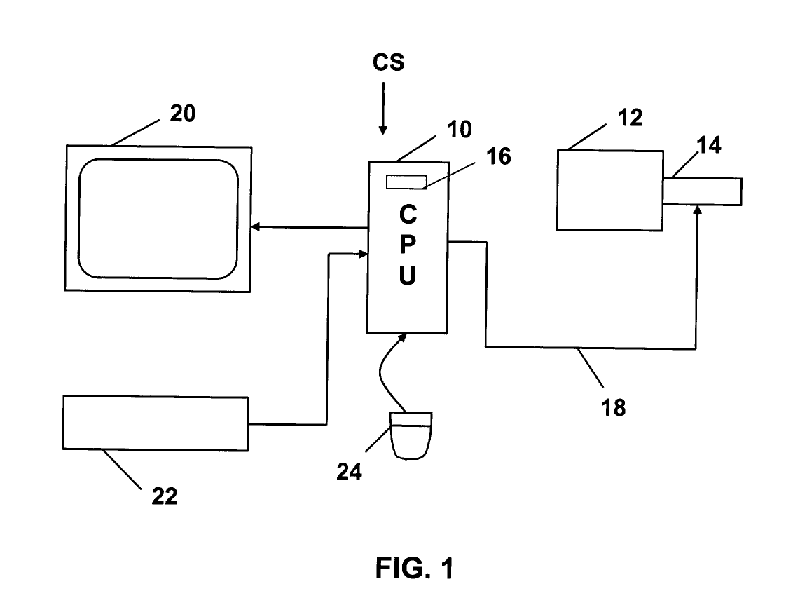

As best shown in FIG. 1, the control system CS of the present invention includes a host computer 10 connected to a camera 12 with a motorized lens 14. The host computer 10 includes therein a PCI card 16, described below in more detail. Preferably, a single cable 18 connects the motorized lens 14 with the PCI card 16. A conventional monitor 20, a keyboard 22, and a mouse 24, are connected to the host computer 10 in a conventionally known manner.

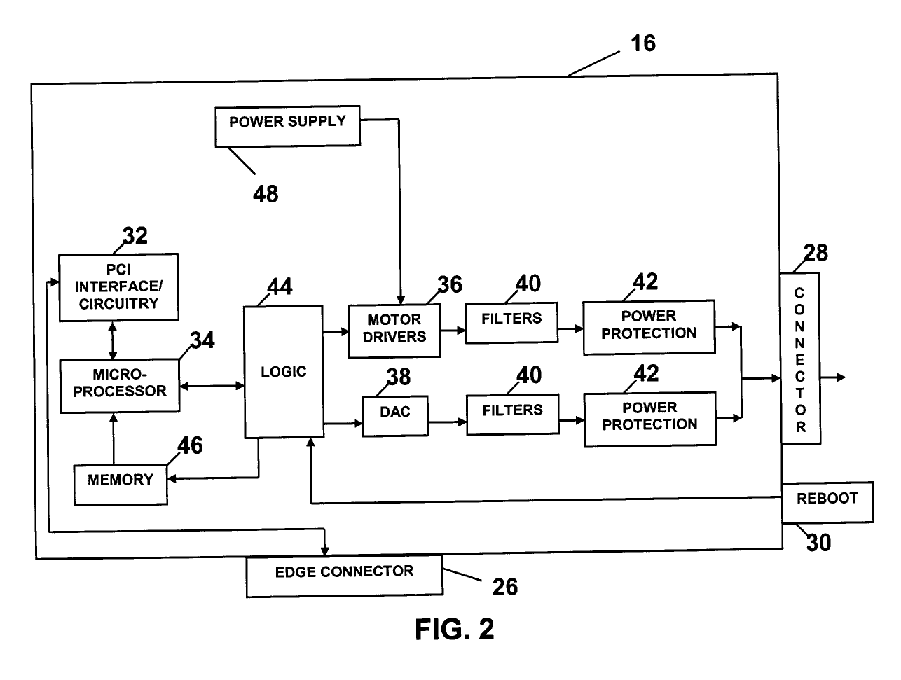

FIG. 2 illustrates the PCI card 16 of the present invention. As shown, the card 16 includes an edge connector 26 that plugs into a PCI socket on a motherboard (not shown) in the host computer 10. The lens cable 18 plugs into, for example, a twenty-five pin connector 28. The PCI card 16 is provided with a reset button 30 to reboot the card.

As further shown in FIG. 2, the PCI card 16 includes a PCI interface 32 that enables communication between the PCI card 16 and the host computer 10. The user's GUI commands are transmitted to the PCI card 16 through the interface circuitry 32. These commands are received by a microprocessor 34 which identifies the command and generates motor control signals to transmit to motor drivers 36, or the digital-to-analog converter (DAC) 38. Since some of the lens motors may require digital signals for control, while others may require analog voltage levels, the drivers 36 provide the appropriate digital signals, and the DAC converter 38 provides the analog signals. The digital signals allow a user to step through a full range of zooming and focusing of the lens 14. On the other hand, the analog signals are used to control, for example, preset zoom and preset focus functions. The preset feature allows the user to immediately reach a predetermined zoom and/or focus position.

Both the digital and analog control signals, preferably pass through corresponding line filters 40 and surge protection 42, prior to exiting the PCI card 16 via the connector 28. A logic 44 interconnects a memory 46, microprocessor 34, motor drivers 36, and the DAC 38. A source 48 provides all the necessary power for driving the lens motors by drawing the power from the host computer 10. Therefore, no additional external power supply is required for the motorized zoom lens.

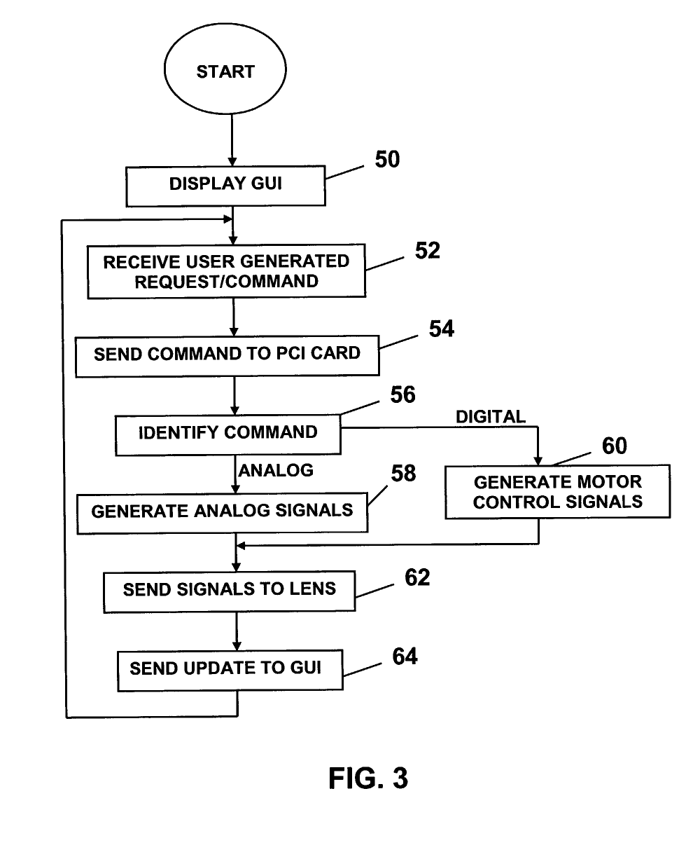

FIG. 3 illustrates a method of the invention for controlling the motorized lens 14 of the camera 12. As shown, upon start, a GUI is displayed (step 50) on the host computer 10 offering the user various options for controlling the lens 14. The GUI will include various choices to select, for example, zoom in (tele), zoom out (wide), focus near, focus far, iris close, iris open, zoom in with auto focus, zoom out with auto focus, zoom in with auto iris, zoom out with auto iris, zoom in with auto iris and auto focus, and zoom out with auto iris and auto focus. The GUI will also allow a selection of various preset positions for the lens. With the selection of a preset position, the GUI will store in memory the position of the focus and zoom at that instant. After moving the lens 14 to a different focus or zoom position, the user can return to the preset position instantly by selecting the preset option. This allows the user to avoid having to determine the lens's last zoomed and focused position. The GUI will also be capable of storing multiple preset positions.

Next, the user selects a position of the lens 14 from the GUI at step 52, which is sent to the PCI card 16 over the host computer PCI bus (step 54). The command is received by the microprocessor 34 which identifies the command (step 56) and generates the correct analog motor control signals (step 58) or digital motor control signals (step 60). The signals are then transmitted to the lens motors (step 62) to move the lens. Finally, the GUI updates the user's display showing the new position of the lens (step 64).

It is noted herewith that a suitable software underlying the overall method of the invention will be created and uploaded on the computer 10, prior to starting thereof.

While this invention has been described as having preferred ranges, steps, materials, or designs, it is understood that it is capable of further modifications, uses and/or adaptations of the invention following in general the principle of the invention, and including such departures from the present disclosure, as those come within the known or customary practice in the art to which the invention pertains and as may be applied to the central features hereinbefore set forth, and fall within the scope of the invention and of the appended claims.

What I claim is:

1. A control system for a camera having a motorized lens with variable positions, comprising:
a) a computer including a screen;
b) said computer including a control component for outputting a signal to actuate the motorized lens to adjust a position of the lens; and
c) said control component disposed in said computer and operably connected to the motorized lens whereby signals from said control component control the motorized lens.

2. The control system of claim 1, wherein:
a) said control component comprises a peripheral component interconnect card; and
b) the motorized lens is controlled by signals from said peripheral component interconnect card.

3. The control system of claim 2, further comprising:
a) a graphical user interface for presenting a menu of lens control options on said computer screen;
b) said menu communicating with said peripheral component interconnect card for controlling the lens in response to a selection made from the graphical user interface menu.

4. The control system of claim 3, wherein:
a) the selection is made by using a device selected from the group consisting of a keyboard, a push button, and a pointing device.

5. The control system of claim 2, further comprising:
a) a cable for operably connecting said peripheral component interconnect card to the motorized lens.

6. The control system of claim 5, wherein:
a) said cable comprises a DB25 connector.

7. The control system of claim 2, wherein:
a) the motorized lens includes means for changing one or more of focus, zoom, and iris positions of the lens.

8. The control system of claim 7, wherein:
a) the motorized lens includes one or more of lens positions selected from the group consisting of zoom in, zoom out, focus near, focus far, iris close, iris open, zoom in with auto focus, zoom out with auto focus, zoom in with auto iris, zoom out with auto iris, zoom in with auto focus and auto iris, and zoom out with auto focus and auto iris.

9. The control system of claim 3, wherein:
a) the motorized lens includes means for changing one or more of focus, zoom, and iris of the lens; and
b) said menu includes a selection to cause a respective change in one or more of focus, zoom, and iris.

10. The control system of claim 7, wherein:
a) the camera includes automatic focus position means operable when the zoom position is changed.

11. The control system of claim 3, wherein:
a) said menu includes a preset camera lens position.

12. The control system of claim 2, wherein:
a) said peripheral component interconnect card includes an interconnector for connecting directly into a computer.

13. The control system of claim 12, wherein:
a) said interconnector comprises an edge connector for connecting directly to a motherboard of said computer.

14. The control system of claim 2, further comprising:
a) means for rebooting said peripheral component interconnect card.

15. A peripheral component interconnect card for enabling communication between a component and a host computer, comprising:
a) a microprocessor for receiving an input command from the computer and generating a digital signal to be communicated to the component; and
b) a digital-to-analog converter for converting the digital signal to an analog signal before communication to the component.

16. The peripheral component interconnect card of claim 15, further comprising:
a) a plurality of motor drivers; and
b) wherein the component comprises a motorized camera lens having one or more of focus, zoom, and iris positions changeable by the lens motors controlled by a signal outputted by the interconnect card.

17. The peripheral component interconnect card of claim 16, wherein:
a) one of the lens motors is controlled by a digital signal; and
b) another of the lens motors is controlled by an analog signal.

18. The peripheral component interconnect card of claim 16, further comprising:
a) logic means;
b) memory means; and
c) said logic means interconnecting said memory means, said microprocessor, said motor drivers, and said digital-to-analog converter.

19. The peripheral component interconnect card of claim 16, further comprising:
a) power supply means connected to said motor drivers for providing power to drive the lens motors.

20. A method of controlling camera lens positions, comprising the steps of:
a) displaying a selection of commands for camera lens positions using a graphical user interface;
b) selecting a lens position from the displayed selection of commands;
c) sending the command to a peripheral component interconnect card;
d) identifying the command, using the peripheral component card, to determine if the command requires an analog or a digital signal to be transmitted; and
e) transmitting the appropriate lens position signal to the camera using said peripheral component card.

21. The method of claim 20, further comprising the step of:
f) updating the graphical user interface when the lens position signal is transmitted to the camera.

22. The method of claim 20, wherein:
the lens position is selected from the group consisting of zoom in, zoom out, focus near, focus far, iris close, iris open, zoom in with auto focus, zoom out with auto focus, zoom in with auto iris, zoom out with auto iris, zoom in with auto focus and auto iris, and zoom out with auto focus and auto iris.
